(19) United States
(12) Patent Application Publication
(10) Pub. No.: US 2007/0041074 A1
(43) Pub. Date: Feb. 22, 2007

(54) Electricallly-cotrollable film having variable optical and/or energy properties

(75) Inventors: Gregoire Mathey, Chateauneuf Sur Loire (FR); Fabien Beteille, Revel (FR); Claude Chevrot, Saint-German En Laye (FR); Dominique Teyssie, Le Pecq (FR); Francois Tran-Van, Saint-Germain En Laye (FR); Frederic Vidal, Guyancourt (FR); Layla Beouch, Pontoise (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 10/564,195

(22) PCT Filed: Jul. 13, 2004
(86) PCT No.: PCT/FR04/01841

§ 371 Date: Oct. 16, 2006

(30) Foreign Application Priority Data
Jul. 16, 2003 (FR) 0308647

(51) Int. Cl. G02F 1/15

(52) U.S. Cl. 359/265

(57) ABSTRACT

The invention relates to an electrically-controllable device with variable optical/energy reflection or transmission properties. The invention is characterised in that the device is shaped in the form of a self-supporting film, said film being formed from a mixture comprising at least one first element which provides the mixture with an electrochrome functionality and at least one second element which produces an electrolyte functionality for ionic charge transfer within said mixture.

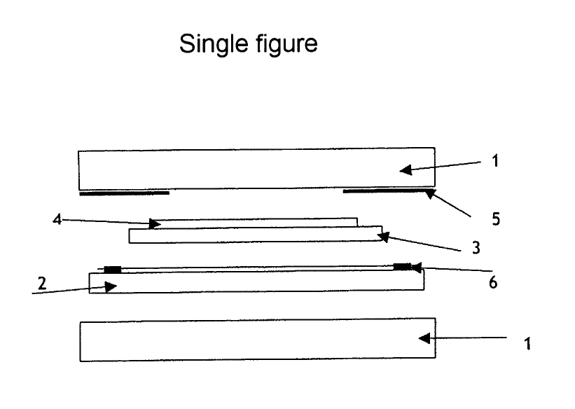

The invention relates to electrically controllable devices having variable optical and/or energy properties. It relates more particularly to devices that use electrochromic systems operating in transmission or in reflection.

Examples of electrochromic systems are described in U.S. Pat. No. 5,239,406 and EP-612 826.

Electrochromic systems have been extensively studied. They are known to comprise in general two layers of electrochromic materials separated by an electrolyte and flanked by two electrodes. Each of the electrochromic layers, under the effect of an electrical supply, can inject charges reversibly, the change in their oxidation state as a result of these injections/ejections resulting in a change in their optical and/or thermal properties (for example, in the case of tungsten oxide, a switch from a blue coloration to a colourless appearance).

It is common practice to classify electrochromic systems in three categories:
that in which the electrolyte is in the form of a polymer or a gel; for example, a protonically conducting polymer such as those described in Patents EP-253 713 or EP-670 346, or a polymer conducting by lithium ions such as those described in Patents EP-382 623, EP-518 754 and EP-532 408, the other layers of the system generally being of an inorganic nature;
that in which the electrolyte is an essentially inorganic layer. This category is often referred to by the term “all-solid-state” system—examples of such may be found in Patents EP-867 752 and EP-831 360, French patent application FR-2 791 147 and French Patent Application FR-2 781 084; and
that in which all the layers are based on polymers, the category then being often referred to by the term “all-polymer” system.

Many applications have already been envisaged for these systems. They are employed most generally as glazing for buildings or as glazing for vehicles, especially as sunroofs, or else, when they operate in reflection and no longer in transmission, as antidazzle rearview mirrors.

Whatever the category of the electrochromic system, the latter generally comprises a stack of functional layers which comprises essentially, two layers of electrochromic material separated by a layer of electrolyte and flanked by two conducting layers. Conventionally, various layers forming this functional stack are deposited on glass substrates or integrated into these substrates by various techniques known to those skilled in the art (CVD, sol/gel technology, magnetron sputtering, spin coating, etc.), which all require, however, to be implemented using very strict operating conditions so as to maintain the optimum properties of the stack.

The object of the prevent invention is therefore to alleviate these drawbacks by proposing an electrically controllable device having variable optical and/or energy properties in transmission or in reflection, which facilitates its incorporation into substrates.

The subject of the invention is therefore an electrically controllable device having variable optical/energy properties in transmission or in reflection, characterized in that it is made as a self-supporting film, the said film being formed from a blend of at least a first element suitable for providing a blend with an electrochromic functionality and at least a second element suitable for providing an electrolyte functionality for transporting ionic charges within the said blend.

Thanks to the use of a self-supporting film incorporating all the materials needed to produce an electrically controllable function, it becomes possible to separate the production of the stack of functional layers from that of the substrates, thus making it possible to maintain standard assembly processes (lamination, calendering, oven treatment, pressing, etc.).

In preferred embodiments of the invention, one or other of the following arrangements may optionally be used:
the blend constitutes a single matrix that is obtained by successive polymerization of the first and second elements initially included in the blend;
the blend constitutes a single matrix that is obtained by simultaneous polymerization of the first and second elements initially included in the blend;
the blend constitutes a single matrix that is obtained by polymerization of the successively included first and second elements;
the first element is a conductive polymer;
the first element is a polymer based on a 3,4-alkylene dioxythiophene or dioxypyrrole or one of its derivatives;
the first element is a polymer based on carbazole or one of its derivatives;
the first element is a polymer based on polyaniline or one of its derivatives;
the first element is a blend of at least two electrochromic materials, at least one having an anodic coloration, the other having a cathodic coloration;
the material having a cathodic coloration is a bipyridine salt;
the material having an anodic coloration is based on 5,10-phenazine or one of its derivatives;
the second element is a polymer chosen from polyoxyalkylenes;
the second element is chosen from polyoxyethylenes or one of its derivatives;
the second element is based on difunctional (acrylate, methacrylate, alcohol, allyl, etc.) poly(ethylene glycol);
the self-supporting film optionally includes a third element suitable for improving its mechanical integrity or for improving the ionic conductivity;
the third element is blended with the second element and their polymerization is simultaneous or successive;
the third element is a polymer chosen especially from polyacrylates, polymethacrylates, polycarbonates, polyacetates, polyurethanes, cellulosics, etc.;
the third element is based on diethylene glycol diallyl carbonate or one of its derivatives, or else poly(ethylene glycol) methyl ether methacrylate;
the film constitutes an interpenetrating network of polymers with at least two components;
the film constitutes a semi-interpenetrating network of polymers with at least two components;
it has a gradient in the composition of the first element along a characteristic dimension of the film; and
it furthermore includes at least one carrier substrate, the said device being placed between two current leads, namely the lower current lead and the upper current lead respectively (“lower” corresponding to the current lead closest to the carrier substrate, as opposed to the “upper” lead which is furthest from the said substrate).

According to another aspect of the invention, this relates to an electrochromic system made up from at least one electrochromic or viologen-based device as described above.

In preferred embodiments of the invention, one or other of the following arrangements may optionally be used:
it constitutes a vehicle sunroof, that can be autonomously actuated, or a vehicle side window or rear window, or a rearview mirror;
it constitutes a windscreen or a portion of a windscreen;
it constitutes a graphical and/or alphanumeric data display panel, glazing for buildings, a rearview mirror, an aircraft windshield or cabin window, or a roof window;
it constitutes interior or exterior glazing for buildings, a shop showcase or countertop display case, which may be curved, glazing for protecting an object of the painting type, an antiglare computer screen, glass furniture, a wall separating two rooms inside a building or two compartments in a motor vehicle;
it operates in transmission or in reflection;
the substrate is transparent, flat or curved, clear or bulk-tinted, and of polygonal shape or at least partly curved;
the substrate is opaque or opacified; and
it incorporates another functionality.

According to yet another aspect of the invention, this is a process for obtaining a device as described above, which is characterized in that:
optionally, the second element is blended with the third element in the presence of at least one polymerization initiator;
the polymerization of the second element is carried out by thermal activation of the blend, and the thermal activation of the blend is continued until the third element has polymerized;
the second and third elements are polymerized or copolymerized in a step by thermal activation of the blend; and
the first element is added to the blend of the second and third elements, the first element is polymerized, by immersion of the blend, with the aid of a polymerization initiator and then the blend is rinsed.

According to another variant of the process, the first element is initially incorporated into the blend of monomers of the second and third elements. After polymerization of the second and third elements with the aid of at least one polymerization initiator, the first element is polymerized, by immersion of the blend, with the aid of a polymerization initiator, and then the blend is rinsed.

The invention will be described in greater detail in conjunction with the appended drawing in which:

the single FIGURE is a schematic view of an electrically controllable device according to the invention, produced according to a first embodiment;

In the appended drawing, some of the elements may be shown on a larger or smaller scale than in reality, so as to make the FIGURE easier to understand.

The single FIGURE shows a glass plate 1 provided with a lower conducting layer 2, with an active stack 3, surmounted by an upper conducting layer 4, with a first grid of conducting wires 5 or an equivalent device for taking the electric current above the upper conducting layer and with a second grid of conducting wires 6 or an equivalent device for taking the electric current below the lower conducting layer 2. The current leads are either conducting wires if the electrochromic active layer is sufficiently conducting, or a grid of wires running over or within a layer forming the electrode, this electrode being made of metal or being of the TCO (Transparent Conductive Oxide) type made of ITO, F:SnO₂ or Al:ZnO, or a single conducting layer.

The conducting wires 5, 6 are metal wires, for example made of tungsten, optionally coated with carbon or with a metal oxide, with a diameter between 10 and 100 μm and preferably between 20 and 50 μm, these being straight or wavy, and placed on a sheet of PU by a technique known in the wire-heated windshield field, for example a technique described in Patents EP-785 700, EP-553 025, EP-506 521 and EP496 669.

One of these known techniques consists in using a heated press wheel that presses the wire against the surface of the polymer sheet, this press wheel being fed with wire from a feed reel via a wire guide device.

The lower conducting layer 2 is a bilayer formed from a 50 nm SiOC first layer surmounted by a 400 nm F:SnO₂ second layer (both layers preferably deposited in succession by CVD on the float glass before cutting).

Alternatively, it may be a bilayer formed from an approximately 20 nm optionally doped SiO₂-based first layer (said layer being especially doped with aluminium or boron) surmounted by an approximately 100 to 350 nm ITO second layer (both layers preferably vacuum-deposited in succession by magnetically enhanced reactive sputtering in the presence of oxygen, and optionally hot).

The upper conducting layer is made in the same way as the lower conducting layer 2.

The active stack 3 shown in the single FIGURE is configured overall as a self-supporting film. Within the context of the present invention, a film is said to be “self-supporting” when, owing to its mechanical properties, it acquires cohesion, making it able to be handled, and retains its shape and its dimensions, which makes it able to be easily handled, transported and assembled. These properties are obtained in the presence of a reinforcing substrate.

This film is obtained from the blend of at least two elements, namely a first element suitable for providing an electrochromic functionality and a second element suitable for providing an ionic charge transport functionality.

In a first embodiment, the blend is obtained by successive polymerization of the successively included first and second elements, the first element being polymerized after the second.

In a second embodiment, the blend is obtained by successive polymerization of a blend of the initially included first and second elements, the first element being polymerized after the second.

In these two embodiments, the first element is chosen from conductive polymers, and more particularly from those based on a 3,4-alkylene dioxythiophene or one of its derivatives, such as for example poly(3,4-ethylenedioxythiophene), called PEDT, formed by chemical polymerization.

For example, a blend of poly(ethylene glycol) dimethacrylate (PEGDM) of variable molar mass (550 and 875 g/mol) and of azobisisobutyronitrile (AIBN) was cast between two glass plates separated by a “Teflon” seal. A heat treatment at 50° C. followed by a postcure at 80° C. allowed polymerization/crosslinking of the methacrylate functional groups. The film was then immersed in a solution of pure ethylenedioxythiophene (EDT) or an organic solution containing EDT in order to allow the monomer to be incorporated into the film. By varying the immersion time it was possible to control the amount of EDT incorporated. The film was then immersed in a solution containing an oxidizing agent (for example FeCl₃). The amount of PEDT in the network was adapted according to how long the film was immersed in the oxidizing solution.

In a second embodiment, the EDT monomer (sold by the company Stark of the Bayer Group) was incorporated into the PEGDM/AIBN blend. During crosslinking of the matrix, the EDT monomer was trapped in the three-dimensional material. Its subsequent polymerization took place as in the previous case by immersion in an oxidizing solution.

According to another example of a conductive polymer used as first element, this polymer is based on carbazole or one of its derivatives formed by chemical polymerization.

For example, polycarbazoles N-substituted with alkyl or oligooxyethylene chains obtained by oxidative chemical synthesis may be used. A macromer having oxyethylene groups containing pendant carbazoles or thiophenes allowing chemical crosslinking is also possible.

Whatever the conductive polymer constituting the first element, it is particularly stable, especially with regard to UV, and operates by injection/ejection of cations (Na⁺, Li⁺, Ca²⁺, Ba²⁺, etc.) or alternatively of H⁺ ions or else anions (CF₃SO₃⁻, BF₄⁻, PF₆⁻, ClO₄⁻, Cl⁻, TFSI, SCN⁻, etc.), these ions being optionally incorporated in the form of molten salts.

According to yet another illustrative example, the first element is not based on a conductive polymer but based on a blend of organic molecules, namely a blend of at least two electrocchromic materials, one having an anodic coloration (based on 5,10-phenazine or one of its derivatives, the other at least having a cathodic coloration (a bipyridine salt)).

The phenazine derivatives used as organic molecules having anodic coloration may be 5,10-dialkyl-5,10-dihydrophenazines or 5,10-bis(2-hydroxypropyl)-5,10-dihydrophenazines or 5,10-dimethoxymethyl-5,10-dihydrophenazines, for example.

The second element, which is associated in the matrix of the film with the first element which acts as electrolyte, is also a polymer. It is chosen from polyoxyalkylenes, and more particularly still is based on polyoxyethylene (POE) or one of its derivatives.

An example of such a polymer may be produced from poly(ethylene glycol) dimethacrylate or (PEGDM) or poly(ethylene glycol) diacrylate or from a polyoxyethylene-based polyester or polyurethane network.

For example, a blend of 2 g of poly(ethylene glycol) dimethacrylate (PEGDM) (sold by Aldrich; M=550 or 875 g/mol), 2 g of poly(ethylene glycol) methacrylate (PEGM) (sold by Aldrich; M=475 g/mol), ethylenedioxythiophene (EDOT) (1 or 2 or 10 wt % relative to the PEGDM and PEGM) and of azobisisobutyronitrile (AIBN) (sold by Aldrich; 1 wt % relative to the PEGDM and PEGM) was cast between two glass plates separated by a “Teflon” (registered trade mark) seal. A heat treatment of 50° C. followed by a postcure at 80° C. allowed polymerization/crosslinking of the methacrylate functional groups. A three-dimensional material was formed in which the EDOT monomer is trapped. The film was then immersed in a solution containing the oxidizing agent (for example FeCl₃, sold by Acros). The amount of PEDOT in the network depended on how long the film was immersed in the oxidizing solution. Using the same operating conditions, PEGDM/PEGM blends ranging from 90/10 to 10/90 by weight could be produced in order to vary the mechanical and ionic conduction properties.

One of the methods for quantifying the mechanical properties of the film consists in using DMA (Dynamic Mechanical Analysis). Shown below in the following table is the tan δ temperature (obtained using this method) for the various PEGDM/PEGM matrices for the different PEGDM molar masses (M=875 and 550 g/mol) and for the various mass ratios (x/y) of PEGDM and PEGM initially introduced.

| Matrices | T_{tanδ} (° C.) |
|---|---|
| PC/PEGDM(M = 875) (50/50) | −36 |
| PEGDM (M = 875)/PEGM (50/50) | −38 |
| PEGDM (M = 875)/PEGM (60/40) | −32 |
| PEGDM (M = 875)/PEGM (80/20) | −31 |
| PEGDM (M = 550)/PEGM (50/50) | −23 |
| PEGDM (M = 550)/PEGM (40/60) | −17 |
| PEGDM (M = 550)/PEGM (70/30) | −11 |

When it is desired to improve the mechanical strength of the self-supporting film formed by the blend of the first and second elements, a third element may be incorporated into the above said blend, the said third element itself possibly consisting of a blend of several polymers.

In one embodiment, this third element is a polymer chosen from polycarbonates, or more particularly still those based on diethylene glycol diallyl carbonate (CR39) or one of its derivatives, or else methacrylate-based monomers such as methyl methacrylate or poly(ethylene glycol) methyl ether methacrylate.

For a 40/40/20 PEGDM/PEGM/PC matrix, a blend of 2 g poly(ethylene glycol) dimethacrylate (PEGDM) (sold by Aldrich: M=875 g/mol), 2 g of poly(ethylene glycol) methacrylate (PEGM) (sold by Aldrich; M=475 g/mol), 1 g of bisallyl carbonate (CR39) (sold by Aldrich; M=274.27 g/mol), ethylenedioxythiophene (EDOT) (sold by Stark; 2 wt % with respect to the PEGDM, PEGM and CR39; M=142 g/mol) was prepared. Added to this blend were 3 wt % of azobisisobutyronitrile (AIBN) (sold by Aldrich) (the percentage being by weight with respect to the PEGDM, PEGM and CR39 initially introduced) and 4 wt % of another polymerization initiator, 1,1′-azobis(cyclohexanecarbonile) (sold by Acros) (the percentage being by weight with respect to the CR39 initially introduced). As previously, the blend was cast between two glass plates separated by a “Teflon” (registered trade mark) seal. A heat treatment at 55° C., then at 80° C. and finally at 100° C., followed by a postcure at 120° C. allowed polymerization/crosslinking of the allyl and methacrylate functional groups. The final polymerization took place, as in the previous case, by immersion in an oxidizing solution. The amount of PEDOT in the network was adapted depending on the amount of time the film was immersed in this oxidizing solution.

The blend of the first, second and possibly third elements, formed into a self-supporting film was then positioned between at least two substrates, each of their faces facing the self-supporting film being covered with upper and lower conducting layers 2, 4 and optionally incorporating the current leads, this assembly then constituting an electrically controllable device having variable optical and/or energy properties.

Prior to assembling the film between the two substrates, the said film was impregnated with an Li⁺ salt or one based on other cations from those already mentioned and optionally with a plasticizer.

This impregnation may be carried out during the film production steps by incorporating, into the blend of monomers of the three elements, the Li⁺ salt in the case when the latter is insoluble in the solvents for washing and for polymerizing the monomer.

In one embodiment of this electrically controllable device, the matrix forms either a network or an interpenetrating network of polymers.

The principle is to polymerize and/or crosslink the blends (of monomers or prepolymers) of the second and third elements containing functional groups, the methods or conditions of polymerization or crosslinking of which are identical or different. In the first case, the matrix is a network, while in the second case the matrix is an interpenetrating network. The presence of the third element is not absolutely essential. In the latter case, the matrix is also a network.

For example, monomers or prepolymers of the second element may polymerize by radical polymerization and monomers of the third element may polymerize by radical, cationic or anionic polymerization, polymers or prepolymers of the second and third elements polymerizing at the same or different temperatures.

The first element providing the electrochromic functionality is introduced either directly into the initial blend of the second and third elements, or by impregnation of the network consisting of the second and third elements. The presence of the third element is not absolutely essential.

In one embodiment, the chemical polymerization of the first element within the interpenetrating networks thus formed is carried out by immersion in a solution containing at least one agent for polymerizing the first element (for example FeCl₃). The networks obtained may be uniform or have a gradient depending on the polymerization solvent, the immersion time, the initial concentrations of the conjugated monomer and the thickness of the film.

Thus, for example, the three monomers forming the first, second and third elements were initially blended in the following manner:

A first network was formed from a blend of the monomers of the second and third elements (in our case, poly(ethylene glycol) dimethacrylate (PEGDM) was blended with diethylene glycol diallyl carbonate (CR39) in the presence of a blend of polymerization initiators (AIBN and POB). The polymerization of the POE (coming from the PEGDM) was carried out at 40° C. The polymerization of the PC (coming from the CR39) was carried out at 80° C. The film formed was then cured at 100° C. At this stage, the first interpenetrating network was obtained.

The polymerization of the first element (that providing the electrochromic functionality) within the first network was obtained by immersing the above first network in an oxidizing solution (FeCl₃, etc.), the excess monomers of the first element that had not reacted being removed by washing the said network obtained, after immersion in a methanol solution.

For example, a functional system based on two uniform self-supporting films, as described above (POE/PC/PEDT) flanking a self-supporting film based on the second and third elements (POE/PC), the assembly combined with active layers forming upper and lower electrodes, is functional and makes it possible to achieve contrasts of greater than 3 between an oxidized state and a reduced state. This assembly is represented in the table below and exhibits optical properties (for example Tl) comparable to those obtained in the case of electrochromic systems known from the prior art (namely those obtained by electrodeposition techniques).

| Immersion time | | | |
|---|---|---|---|
| in the oxidizing | T_{L} oxidized | T_{L} Reduced | |
| solution | state (%) | state (%) | Contrast |
| 5 minutes | 14.3 | 3.7 | 3.6 |
| 10 minutes | 9.0 | 1.6 | 5.6 |

In a second embodiment of the self-supporting film, the network was obtained again using the main steps of the process for obtaining the previous network.

The first network formed from the second and third elements was obtained in a similar manner except as regards the presence of the first element. The latter was not initially present in the blend with the other two.

The first network (POE/PC) in a polymerized form was immersed in a monomer solution based on the first pure element (in our example, it will be recalled that the first element was especially based on EDT). After swelling of the matrix of the POE/PC network with EDT, the polymerization was carried out by immersing the swollen first network in an oxidizing solution (FeCl₃, iron tosylate, etc.). Since the penetration of the monomer and then the polymerization agent into the swollen matrix was not uniform through the thickness of the self-supporting film, the network obtained had a gradient.

The amount of PEDT was greater on the surface than at the centre of the film. By varying the nature of the solvent of the polymerization solution, the gradient could be adjusted.

The formation of the conductive polymer gradient in the insulating matrix may be monitored by the change in ratio of the ohmic surface resistance of the film to the in-thickness resistance. By monitoring the change of this ratio as a function of the immersion time for the various solvents, the influence of the nature of the solvent and of the matrix on the polymerization rate was able to be observed. By controlling the immersion time for a given solvent, it was possible to control the conductive polymer gradient in the film.

The illustrative example shows that the electrically controllable device incorporating a self-supporting film with a gradient between two glass substrates that are provided, at their respective face facing the film, with the active layers (and with the optional current leads) makes it possible to achieve contrasts of greater than 3 between an oxidized state and a reduced state.

Likewise, prior to assembling the film between the two substrates, the said film was impregnated with an Li⁺ salt or one based on another cation and optionally with a plasticizer.

This impregnation may be carried out during the film production steps by incorporating, into the blend of monomers of the three elements, the Li⁺ salt or one based on another cation.

These self-supporting films have a number of advantages compared with a conventional assembly technique (deposition of layers):
a single film can be used industrially to insert the electrochromic functions in the envisaged applications (described below);
the interpenetration of the two polymer species (the electrochromic polymer and the polymer electrolyte) with a conductive polymer gradient in the matrix generates external layers creating de facto surfaces for contact with the electrodes (anode and cathode) without having their drawbacks (delamination); and
the electrochromic material is partially protected from the outside, consequently increasing the lifetime of the electrically controllable device.

Moreover, the two glass plates forming the substrates of the electrically controllable device and described above are made of standard, flat clear silica-soda-lime glass each approximately 2 mm in thickness.

The invention applies in the same way to curved and/or toughened glass substrates.

Likewise, at least one of the glass substrates may be bulk-tinted, especially tinted blue or green, grey, bronze or brown.

The substrates used in the invention may also be based on a polymer (PMMA, PET, PC, etc.). It should also be noted that the substrates may have very varied geometrical shapes: they may be in the form of a square or rectangle, but also in the form of any polygon or at least partly curved profile, defined by rounded or undulating contours (round, oval, “waves”, etc.).

Moreover, at least one of the two glass substrates (on that face which is not provided with the electrochromic or equivalent system) may be covered with a coating having another functionality (this other functionality possibly being, for example, a solar-protection stack, an antifouling stack or the like). As regards the solar-protection stack, this may be a stack of thin layers deposited by sputtering and including at least one silver layer. It is thus possible to have combinations of the following types:
glass/electrochromic system/solar-protection layers/glass;
glass/electrochromic system/glass/thermoplastic/glass; and
glass/electrochromic system/thermoplastic/glass.

The thermoplastic may be chosen from PVB, PU and EVA.

The solar-protection coating may also be deposited, not on one of the glass substrates, but on a sheet of flexible polymer of the PET (polyethylene terephthalate) type.

For examples of solar-protection coatings, the reader may refer to patents EP 826 641, EP 844 219, EP 847 965, WO99/45415 and EP 1 010 677.

The device forming the subject of the invention described above may also be incorporated into a three-glass “substrate”, the latter being advantageously used for the production of glazing that meets the safety requirements.

1. An electrically controllable device with variable optical/energy properties in transmission or in reflection, comprising a single self-supporting film, the said film being formed from a polymerized blend of at least a first element suitable for providing a blend with an electrochromic functionality and at least a second element suitable for providing an electrolyte functionality for transporting ionic charges within the said blend.

2. The device according to claim 1, wherein the blend constitutes a single matrix that is obtained by simultaneous polymerization of the first and second elements.

3. The device according to claim 1, wherein the blend constitutes a single matrix that is obtained by successive polymerization of the first and second elements.

4. The device according to claim 1, wherein the first element is a conductive polymer.

5. The device according to claim 4, wherein the first element is a polymer based on a 3,4-alkylene dioxythiophene or one of its derivatives.

6. The device according to claim 4, wherein the first element is a polymer based on carbazole or one of its derivatives.

7. The device according to claim 1, wherein the first element is a blend of at least two electrochromic materials, at least one having an anodic coloration, the other having a cathodic coloration.

8. The device according to claim 7, wherein the material having a cathodic coloration is a bipyridine salt.

9. The device according to claim 7, wherein the material having an anodic coloration is based on 5,10-phenazine or one of its derivatives.

10. The device according to claim 1, wherein the second element is a polymer chosen from polyoxyalkylenes.

11. The device according to claim 10, wherein the second element is chosen from polyoxyethylenes or one of its derivatives.

12. The device according to claim 10, wherein the second element is based on difunctional poly(ethylene glycol) or one of its derivatives.

13. The device according to claim 1, wherein the self-supporting film includes at least one third element suitable for improving its mechanical integrity or for improving the ionic conductivity.

14. The device according to claim 13, wherein the third element is a polymer selected from the group consisting of polyacrylates, polymethacrylates, polycarbonates, polyacetates, polyurethanes, cellulosics and mixtures thereof.

15. The device according to claim 13, wherein the third element is based on diethylene glycol diallyl carbonate or one of its derivatives, or else poly(ethylene glycol) methyl ether methacrylate.

16. The device according to claim 1, wherein the film constitutes an interpenetrating network.

17. The device according to claim 1, wherein the film constitutes a semi-interpenetrating network.

18. The device according to claim 1, wherein the device has a gradient in the composition of the first element along a characteristic dimension of the film.

19. A system comprising at least one device according to claim 1, wherein the system further comprises at least one carrier substrate, wherein the device is placed between a lower current lead and an upper current lead wherein the lower current lead is closest to the carrier substrate, and the upper current lead is furthest from the carrier substrate.

20. The system according to claim 19, wherein the system is an electrochromic or viologen-based system.

21. The system according to claim 19, wherein the system constitutes a vehicle sunroof, that can be autonomously actuated, or a vehicle side window or rear window, or a rearview mirror.

22. The system according to claim 19, wherein the system constitutes a windscreen or a portion of a windscreen.

23. The system according to claim 19, wherein the system constitutes a graphical and/or alphanumeric data display panel, glazing for buildings, a rearview mirror, an aircraft windshield or cabin window, or a roof window.

24. The system according to claim 19, wherein the system constitutes:
interior or exterior glazing for buildings;
a shop showcase or countertop display case, which may be curved;
glazing for protecting an object of the painting type;
an antiglare computer screen;
glass furniture;
a wall separating two rooms inside a building or two compartments in a motor vehicle.

25. The system according to claim 19, wherein the system operates in transmission or in reflection.

26. The system according to claim 19, wherein the substrate is transparent, flat or curved, clear or bulk-tinted, and of polygonal shape or at least partly curved.

27. The system according to claim 19, wherein the substrate is opaque or opacified.

28. The system according to claim 19, wherein the system incorporates another functionality.

29. A process for producing the device according to claim 1, wherein:
optionally, the second element is blended with the third element in the presence of a polymerization initiator;
the polymerization of the second element is carried out by thermal activation of the blend, and the thermal activation of the blend is continued until the third element has polymerized; and
the second and third elements are polymerized or copolymerized in a step by thermal activation of the blend.

30. The process according to claim 29, wherein:
the first element is added to the blend of the second and third elements;
the first element is polymerized, by immersion of the blend, with the aid of a polymerization initiator; and
the blend is rinsed.

31. The process according to claim 29, wherein:
the polymerized blend of the second and third elements is brought into contact in a bath based on the first element;
the first element is polymerized, by immersion of the blend, with the aid of a polymerization initiator; and
the blend is rinsed.

32. The process according to claim 29, wherein the film is impregnated with an Li⁺ salt, or one based on another cation, and optionally with a plasticizer.

33. The process according to claim 29, wherein the impregnation of the film is carried out during the film production steps, by incorporating a charge provider into the blend of monomers of the three elements.
